(19) United States
(12) Patent Application Publication
(10) Pub. No.: US 2018/0050381 A1
(43) Pub. Date: Feb. 22, 2018

(54) PREPARING HOLES ON RULES OR PROFILES USED FOR CHANNEL LETTERS

(71) Applicant: Seoul Laser Dieboard System Co., Ltd., San Diego, CA (US)

(72) Inventor: Kyong Chan Lim, San Diego, CA (US)

(21) Appl. No.: 15/629,565

(22) Filed: Jun. 21, 2017

Related U.S. Application Data
(60) Provisional application No. 62/352,942, filed on Jun. 21, 2016.

(51) Int. Cl. B21D 35/00

(52) U.S. Cl. CPC B21D 35/001; G09F 13/0404

(57) ABSTRACT

Preparing holes on rules or profiles used for a channel letter includes: determining a type of the holes to be prepared on the rules or profiles, wherein the type of holes determines a placement of the holes along at least a vertical direction of the rules or profiles; determining and measuring positions along a longitudinal direction for the holes to be prepared on the rules or profiles; making the holes at the positions along the longitudinal direction; and bending the rules or profiles into the channel letter.

### CROSS-REFERENCE TO RELATED APPLICATIONS

This application claims the benefit of priority under 35 U.S.C. § 119(e) of co-pending U.S. Provisional Patent Application No. 62/352,942, filed Jun. 21, 2016, entitled “Preparing Holes on Rules or Profiles Used for Channel Letters.” The disclosure of the above-referenced application is incorporated herein by reference.

### BACKGROUND

### Technological Field

The present disclosure relates to channel letters, and more specifically, to preparing holes on rules or profiles used for the channel letters.

### Background

Once a rule or profile is folded into a channel letter, the channel letter is attached to the bottom plate, light fixtures are placed on top of the bottom plate, and the top plate is attached to or placed on top of the channel letter to form a box of letter or shape (hereinafter referred to as “letter box”).

However, under certain weather conditions and with the light fixtures operating inside the letter box, moisture may build up in the letter box. The buildup of the moisture or water may cause the light fixtures to fail.

### SUMMARY

This disclosure describes apparatus and methods related to preparing holes on rules or profiles used for channel letters. A rule, for the purposes of this application, is a strip of material used to form a channel letter or shape (hereinafter referred to as “channel letter”). A profile may refer to a rule with rib(s) attached to it. In general, the rule or profile may be interchangeably used. In general, the rule or profile may be interchangeably used.

In one embodiment, a method for preparing holes on rules or profiles used for a channel letter is disclosed. The method includes: determining a type of the holes to be prepared on the rules or profiles, wherein the type of holes determines a placement of the holes along at least a vertical direction of the rules or profiles; determining and measuring positions along a longitudinal direction for the holes to be prepared on the rules or profiles; making the holes at the positions along the longitudinal direction; and bending the rules or profiles into the channel letter.

In another embodiment, an apparatus for preparing holes on rules or profiles used for a channel letter is disclosed. The apparatus includes: means for determining a type of the holes to be prepared on the rules or profiles along at least a vertical direction of the rules or profiles; means for determining positions along a longitudinal direction for the holes to be prepared on the rules or profiles; means for making the holes at the positions along the longitudinal direction; and means for bending the rules or profiles into the channel letter

In another embodiment, a device configured to prepare holes on rules or profiles used for a channel letter is disclosed. The device includes: a processor configured to determine a type of the holes to be prepared on the rules or profiles, wherein the type of holes determines a placement of the holes along at least a vertical direction of the rules or profiles, the processor also configured to determine and measure positions along a longitudinal direction for the holes to be prepared on the rules or profiles; and a boring unit configured to make the holes at the positions along the longitudinal direction.

Other features and advantages of the present disclosure should be apparent from the following description which illustrates, by way of example, aspects of the disclosure.

### BRIEF DESCRIPTION OF THE DRAWINGS

The details of the present disclosure, both as to its structure and operation, may be gleaned in part by study of the accompanying drawings.

FIG. 1A shows the rule bent into a channel letter shape.

FIG. 1B shows the completed channel letter (e.g., letter “K”).

FIG. 2A shows a strip of rule.

FIG. 2B shows a flange formed on the rule.

FIG. 2C shows one side surface of a strip of profile.

FIG. 2D shows the other side surface of the strip of profile.

FIG. 3A shows several examples of the letter box shaped as letters S, T, and M.

FIG. 3B shows drainage holes measured and punched and/or drilled on the rule.

FIG. 3C shows the process of measuring the drainage hole placement in accordance with one embodiment of the present disclosure.

FIG. 4 shows one example of the drainage hole on a profile.

FIG. 5A shows one example of the screw on a profile.

FIG. 5B shows one example of the screw hole made to accept the screw and engage the clip, which is used to couple the channel letter to the base plate.

FIGS. 6A and 6B show examples of decoration holes disposed on a channel letter in accordance with one embodiment of the present disclosure.

FIG. 7 is a block diagram of a device for preparing holes on a rule or profile used for a channel letter in accordance with one embodiment of the present disclosure.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. In some instances, well-known structures and components are shown in simplified form for brevity of description. As used herein, like reference numerals refer to like features throughout the written description.

Apparatus and methods for preparing holes on rules or profiles used for channel letters are described. A rule, for the purposes of this application, is a strip of material used to form a channel letter or shape (hereinafter referred to as “channel letter”). A profile may refer to a rule with rib(s) attached to it. In general, the rule or profile may be interchangeably used.

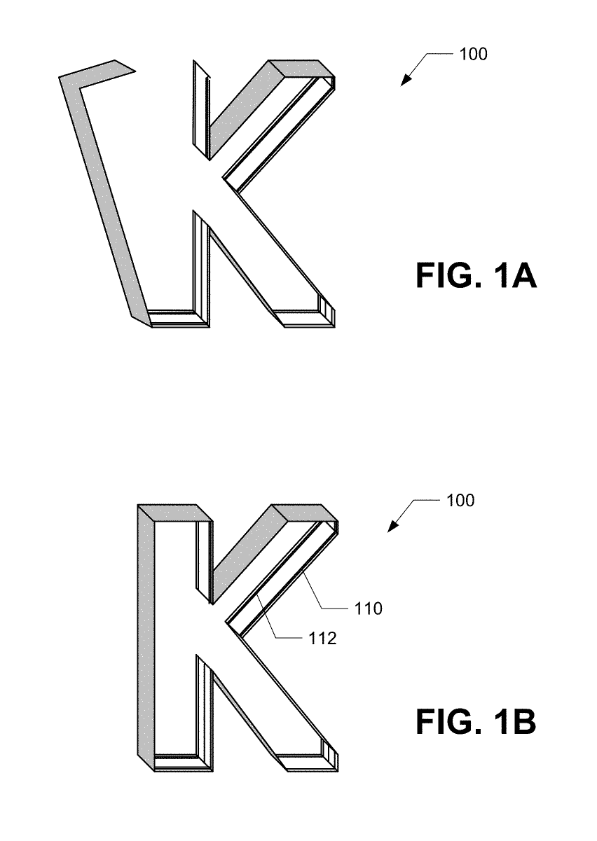

Rules (or profiles) may be used to form channel letters. For example, FIGS. 1A and 1B show a channel letter box 100 made with a profile in accordance with one embodiment of the present disclosure. FIG. 1A shows the rule bent into a channel letter shape. FIG. 1B shows the completed channel letter (e.g., letter “K”). As can be seen in FIG. 1B, for example, the channel letter box 100 includes a top rib 110 for retaining the top plate and a bottom rib 112 for fitting into a bottom plate. In one embodiment, the channel letter can be shaped into any shape, not just a letter of the alphabet or writing (e.g., Chinese letters). For example, the channel letter can be in a shape such as a heart shape.

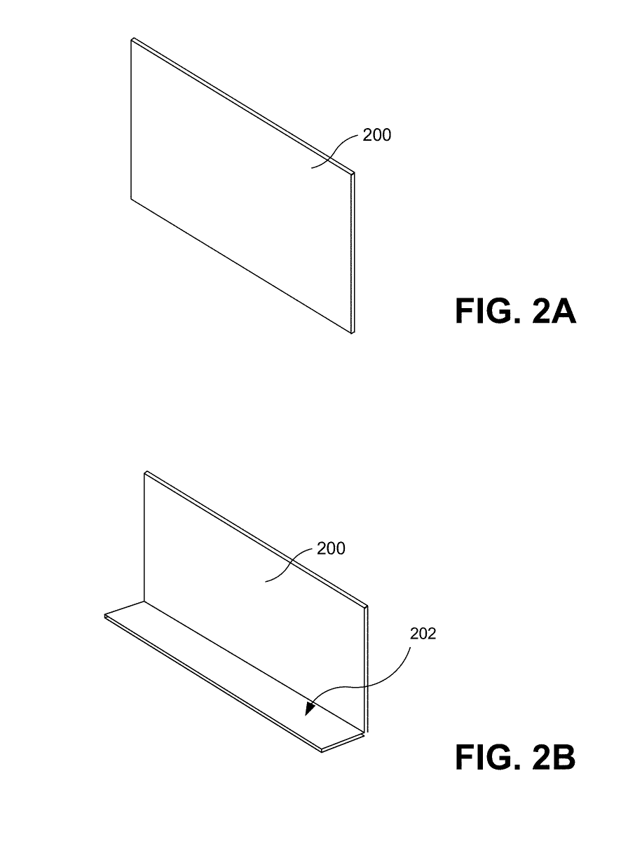

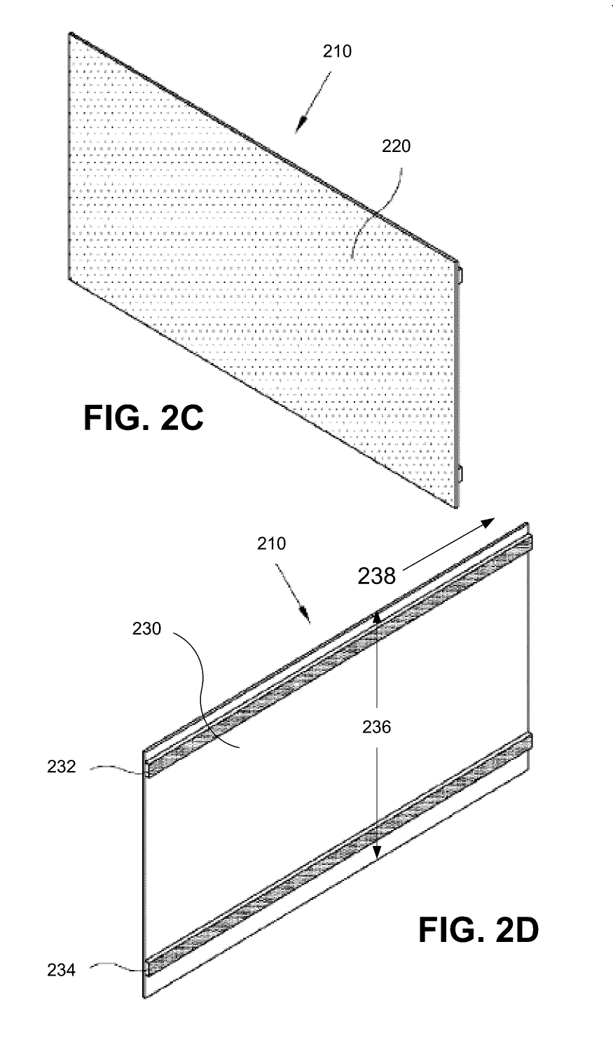

In one embodiment, the rules can be made into strips or rolls. FIG. 2A shows a strip of rule 200. FIG. 2B shows a flange 202 formed on the rule 200. FIG. 2C shows one side surface 220 of a strip of profile 210. FIG. 2D shows the other side surface 230 of the strip of profile 210. The other side surface 230 may include ribs 232, 234 to support the top and bottom covers of a channel letter. Thus, in one embodiment, a profile can be formed using a rule with at least one strip of rib attached to one surface of the rule.

In some embodiments, the profile 210 can have a first surface 230 shown in FIG. 2D. The first surface 230 may also be referred to herein as the “inside surface,” indicating that the first surface 230 may generally become the inside of a resulting channel letter once the profile 210 has been cut and folded. The profile 210 (or the rule 200) can generally have a profile height 236 on the order of a few centimeters (cm), for example, one or two cm to in excess of 20 cm. The profile height 236 can also describe the height of the first surface 230. The profile 210 may also be many meters long (in the direction of the profile axis 238). In some embodiments, the profile 210 (and the rule 200) can be stored in large rolls from which certain portions or lengths can be cut, for example, to produce the portion of the profile 210 shown. Lengths or sections of the profile 210, can be cut from the roll and then fed into a profile cutting and bending machine (not shown) to make a variety of channel letters or shapes from the profile 210.

In some embodiments, the rule 210 can be formed of a suitable metallic material, such as aluminum, steel, stainless steel, or various other alloys that provide a malleable, yet sturdy construction. The rule 210 may further have a protective coating to prevent corrosion or oxidation and to provide a suitable mounting surface for the ribs 232, 234. Such a protective coating can be applied at least to the first surface 230, but can also be applied to an outside surface 220. The outside surface 220 is opposite the first surface 230 and may generally become the outside of the resulting channel letter once the profile 210 is cut and folded.

In certain embodiments, such a protective coating may be an enamel coating. In some other embodiments, the profile 210 can be coated with certain types of powder coating, lacquer, or paint applied to the entire rule 200. In some embodiments, coating the rule 200 in enamel can have certain chemical advantages for adhering or bonding of the ribs 232, 234. The coating can further have desirable artistic or design characteristics provided by different colored coatings having various reflective or textured properties. For example, a white first surface 230 may have desirable reflective properties for light emitted from within a completed channel letter. The colors and coatings of the first surface 230 can be different from the colors and coatings of the outside surface.

As described above, the profile 210 can further have the ribs 232, 234. In some embodiments, the ribs 232, 234 can be attached, bonded, or otherwise adhered to the first surface 230 of the profile 210. In some embodiments, the ribs 232, 234 can be formed of a polymer, elastomer, plastic, fiber-reinforced plastic (FRP), or other suitable synthetic materials. In some other embodiments, the rib 232, 234 can be attached using a machine that applies or adheres the ribs 232, 234 in place on a blank surface 230 of the profile 210.

As described above, once the rule or profile is folded into a channel letter, the channel letter is attached to the bottom plate, light fixtures are placed on top of the bottom plate, and the top plate is attached to or placed on top of the channel letter to form a box of letter or shape. However, under certain weather conditions and with the light fixtures operating inside the letter box, moisture may build up in the letter box. The buildup of the moisture or water may cause the light fixtures to fail.

Embodiments of the present disclosure also include preparing holes on rules or profiles used for channel letters. In one embodiment, the holes are configured as drainage holes. In another embodiment, the holes are configured as screw holes. In yet another embodiment, the holes are configured as decoration holes to enhance the appearance of the channel letter when the light inside the channel letter is turned on.

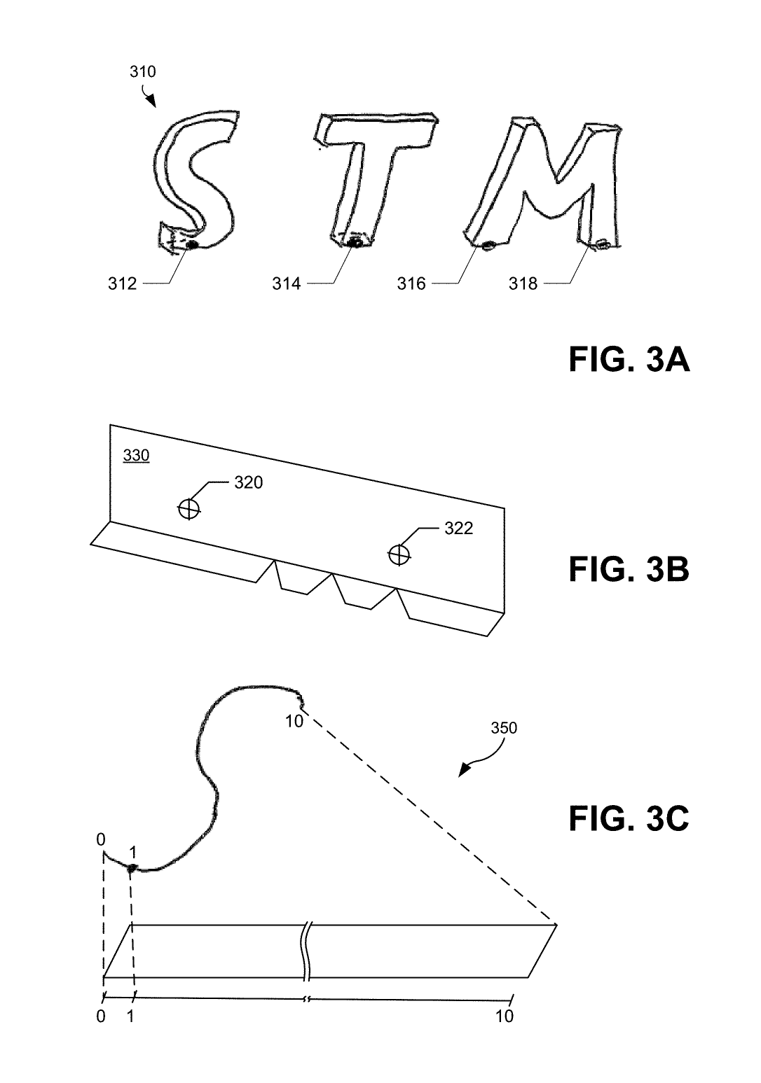

FIG. 3A shows several examples of the letter box 310 shaped as letters S, T, and M. In accordance with embodiments of the present disclosure, drainage holes 312, 314, 316, 318 may be formed or prepared at the bottom of the letter box. In the example of letter M, more than one drainage holes 316, 318 may be formed.

In the illustrated embodiment of FIG. 3A, the drainage holes 312, 314, 316, 318 are determined, measured, marked, and/or drilled using a punch apparatus including a processor, for example, prior to, during, or subsequent to the bending and cutting process. In one example, bending and/or cutting is done using a bending/cutting apparatus. At least one of the processes of measuring, marking, and drilling can be done in the same apparatus which does the bending and cutting of the rule or profile to make the channel letter. In one embodiment, the punch apparatus and the bending/cutting apparatus are configured into a single device such that measuring, marking, drilling, and bending/cutting operations are all done in the single device. In another embodiment, measuring, marking, and bending/cutting operations are done in the bending/cutting apparatus, and drilling is done in the punching apparatus. In another embodiment, different combinations of operations are done in the punch apparatus and the bending/cutting apparatus.

As shown in FIG. 3B, drainage holes 320, 322 are measured and punched and/or drilled on the rule 330, for example, prior to bending/cutting using an apparatus (which may be the same apparatus as the bending/cutting apparatus). In other embodiments, the holes 320, 322 are measured and marked so that the holes can be punched or drilled later, subsequent to the bending and cutting of the rule 330 into the channel letter.

FIG. 3C shows a process 350 of measuring the hole placement in accordance with one embodiment of the present disclosure. In the illustrated embodiment of FIG. 3C, once the channel letter to be formed is determined (e.g., letter S in FIG. 3C), the processor determines the length of the rule to be folded into the channel letter and the hole placement data. The hole is then marked and/or drilled (or punched).

For example, in FIG. 3C, a drainage hole is to be punched or drilled at the bottom of letter S. The processor first determines the length of letter S to be 10 units long and that the bottom where the moisture is to be drained is 1 unit of distance from the left side. The processor instructs the apparatus to move the rule or profile 1 unit to the left and then instructs the drill/punch to make a hole for drainage.

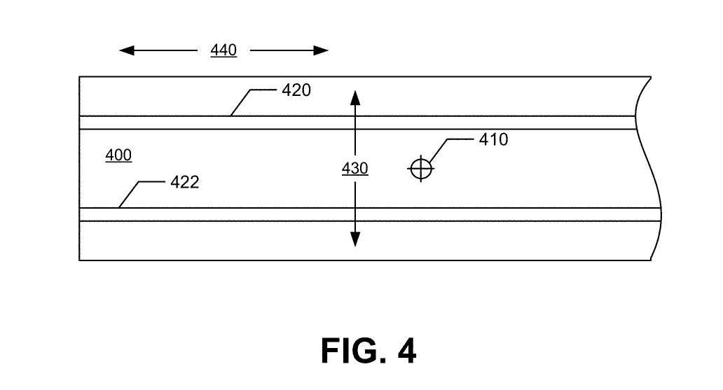

FIG. 4 shows one example of a drainage hole 410 on a profile 400 in accordance with one embodiment of the present disclosure. In the illustrated embodiment of FIG. 4, the profile 400 includes a pair of ribs 420, 422 coupled to one surface of the profile. Generally, the drainage holes (e.g., drainage hole 410) are placed near the middle of the profile along the perpendicular direction 430 (“vertical direction”) to the profile feeding direction 440 (“longitudinal direction”) so that the water can drain evenly. The exact placement of the holes are programmed and/or determined by the processor. The profile feeding direction 440 is the direction which the profile is fed into the apparatus to be hole punched and/or folded.

In addition to the drainage holes, the channel letter formed with profiles (or even with the channel letter formed with rules) may need screw holes to hold the clips in place. In one embodiment, the clips are used to insert the channel letter into the base plate.

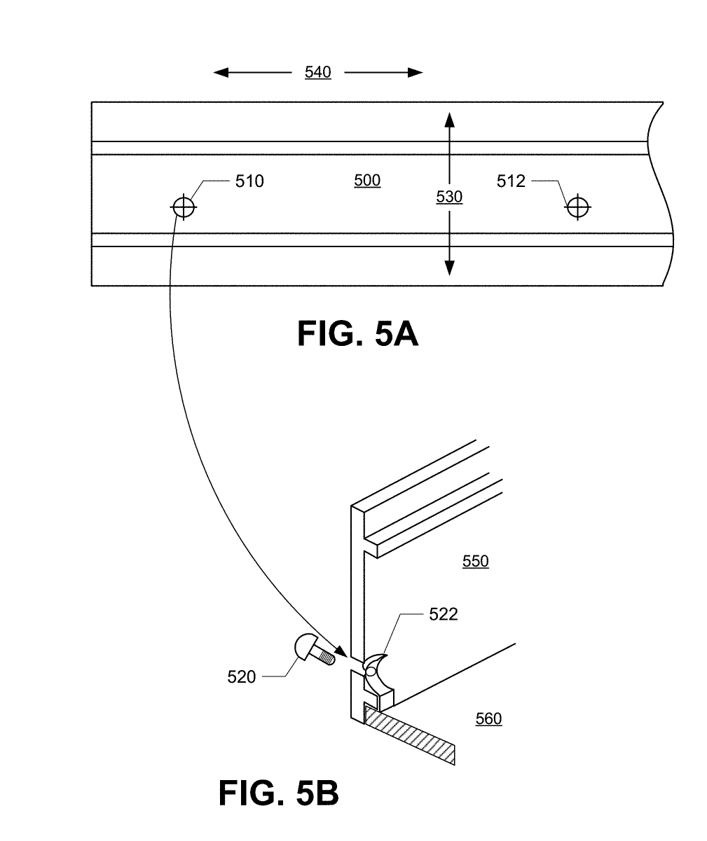

FIG. 5A shows one example of screw holes 510, 512 disposed on a profile 500 in accordance with one embodiment of the present disclosure. Generally, the screw holes (e.g., screw holes 510, 512) are placed near the bottom of the profile along the perpendicular direction 530 to the profile feeding direction 540 so that the screw can fit through a screw hole and a clip positioned above the bottom rib. The exact placement of the holes are programmed and/or determined by the processor. In the description above, the top of the profile generally refers to the side of the channel letter that is facing the outside, while the bottom of the profile generally refers to the side of the channel letter that is facing the surface (e.g., a wall) onto which the channel letter is attached.

FIG. 5B shows one example of the screw hole 510 made to accept the screw 520 and engage the clip 522, which is used to couple the channel letter 550 to the base plate 560. Typically, the base plate 560 is attached to a surface on which the channel letter will be displayed.

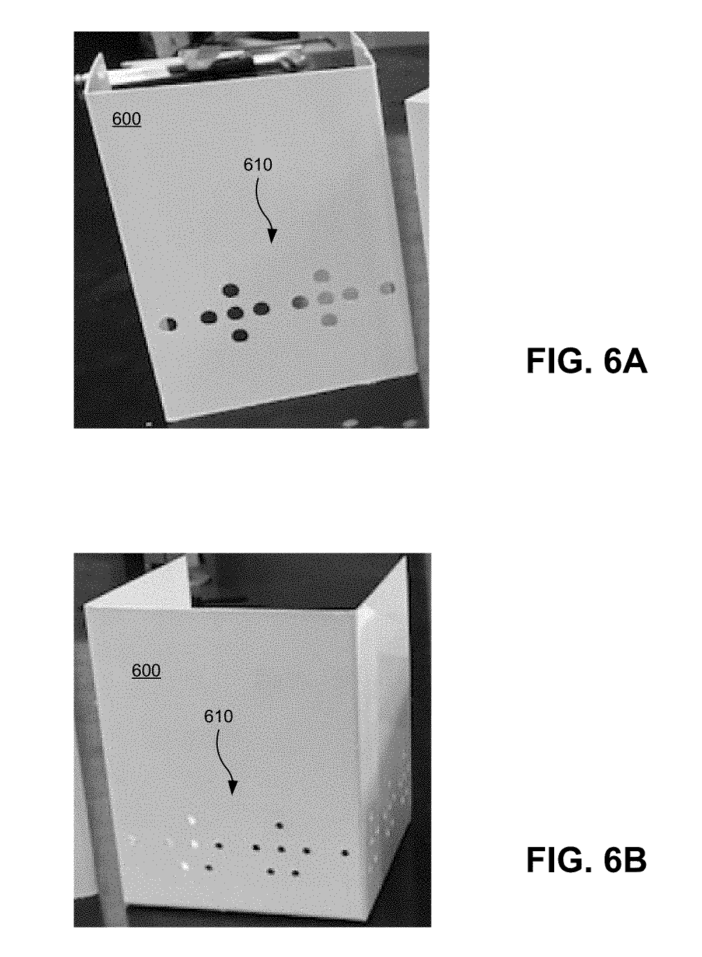

FIGS. 6A and 6B show examples of decoration holes 610 disposed on a channel letter 600 in accordance with one embodiment of the present disclosure. In the illustrated embodiment of FIGS. 6A and 6B, the holes 610 are configured as decoration holes to enhance the appearance of the channel letter 600 when the light inside the channel letter is turned on.

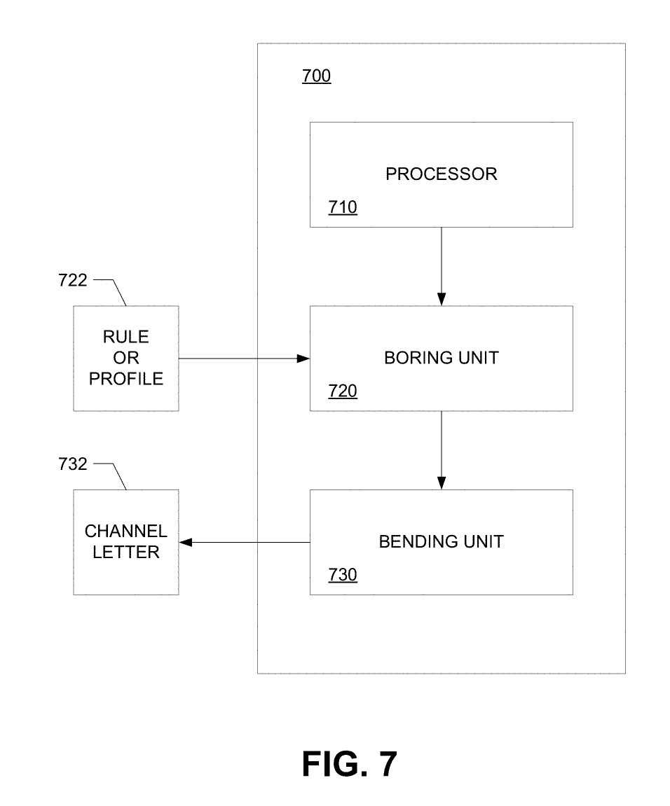

FIG. 7 is a block diagram of a device 700 for preparing holes on a rule or profile used for a channel letter in accordance with one embodiment of the present disclosure. In the illustrated embodiment of FIG. 7, the device 700 includes a processor 710, a boring unit 720, and a bending unit 730.

The processor 710 is configured to determine a type of the holes to be prepared on the rule or profile 722, wherein the type of holes determines a placement of the holes along at least a vertical direction of the rule or profile. The processor 710 is also configured to determine and measure positions along a longitudinal direction for the holes to be prepared on the rule or profile. The boring unit 720 is configured to receive the rule or profile 722 and make the holes at the positions along the longitudinal direction of the rule or profile 722. The type of holes includes a drainage hole, a screw hole, and a decoration hole. In general, the drainage hole is placed near the middle of the rule or profile 722 along the vertical direction, while the screw hole is placed near the bottom of the rule or profile 722 along the vertical direction. In one embodiment, the boring unit includes at least one of a punching unit and a drill unit. The bending unit 730 is configured to bend the rules or profiles into the channel letter 732.

The above descriptions of the disclosed embodiments are provided to enable any person skilled in the art to make or use the disclosure. Various modifications to these embodiments will be readily apparent to those skilled in the art, and the generic principles described herein can be applied to other embodiments without departing from the spirit or scope of the disclosure. For example, although the examples describe only include three types of holes (i.e., drainage, screw, and decoration), other types of holes (e.g., access holes for maintenance) can be made using the apparatus and methods as described in the description section of the present disclosure. Thus, it will be understood that the description and drawings presented herein represent embodiments of the disclosure and are therefore representative of the subject matter which is broadly contemplated by the present disclosure. It will be further understood that the scope of the present disclosure fully encompasses other embodiments that may become obvious to those skilled in the art and that the scope of the present disclosure is accordingly limited by nothing other than the appended claims.

Accordingly, the foregoing embodiments are merely presented as examples and are not to be construed as limiting the present disclosure. The present teachings can be readily applied to other types of apparatus and/or devices. The description of the present disclosure is intended to be illustrative, and not to limit the scope of the claims. Many alternatives, modifications, and variations will be apparent to those skilled in the art.

What is claimed is:

1. A method for preparing holes on rules or profiles used for a channel letter, the method comprising:
determining a type of the holes to be prepared on the rules or profiles,
wherein the type of holes determines a placement of the holes along at least a vertical direction of the rules or profiles;
determining and measuring positions along a longitudinal direction for the holes to be prepared on the rules or profiles;
making the holes at the positions along the longitudinal direction; and
bending the rules or profiles into the channel letter.

2. The method of claim 1, wherein the type of holes comprises
a drainage hole, a screw hole, and a decoration hole.

3. The method of claim 2, wherein the drainage hole is placed near the middle of the rule or profile along the vertical direction.

4. The method of claim 2, wherein the screw hole is placed near the bottom of the rule or profile along the vertical direction.

5. The method of claim 1, wherein making the holes comprises
at least one of punching and drilling the holes.

6. The method of claim 1, wherein the steps of determining, measuring, making, and bending are performed by a single apparatus.

7. The method of claim 1, wherein the steps of determining, measuring, and making are performed in a first apparatus and the step of bending is performed in a second apparatus.

8. An apparatus for preparing holes on rules or profiles used for a channel letter, the apparatus comprising:
means for determining a type of the holes to be prepared on the rules or profiles along at least a vertical direction of the rules or profiles;
means for determining positions along a longitudinal direction for the holes to be prepared on the rules or profiles;
means for making the holes at the positions along the longitudinal direction; and
means for bending the rules or profiles into the channel letter.

9. The apparatus of claim 8, wherein the type of holes comprises
a drainage hole, a screw hole, and a decoration hole.

10. The apparatus of claim 8, wherein means for making the holes comprises means for punching or drilling the holes.

11. A device for preparing holes on rules or profiles used for a channel letter, the device comprising:
a processor configured to determine a type of the holes to be prepared on the rules or profiles, wherein the type of holes determines a placement of the holes along at least a vertical direction of the rules or profiles,
the processor also configured to determine and measure positions along a longitudinal direction for the holes to be prepared on the rules or profiles; and
a boring unit configured to make the holes at the positions along the longitudinal direction.

12. The device of claim 11, wherein the type of holes comprises
a drainage hole, a screw hole, and a decoration hole.

13. The device of claim 12, wherein the processor is configured to place the drainage hole near the middle of the rule or profile along the vertical direction.

14. The device of claim 12, wherein the processor is configured to place the screw hole near the bottom of the rule or profile along the vertical direction.

15. The device of claim 11, wherein the boring unit comprises
at least one of a punching unit and a drill unit.

16. The device of claim 11, further comprising
a bending unit configured to bend the rules or profiles into the channel letter.
